(19) United States
(12) Patent Application Publication
(10) Pub. No.: US 2025/0104056 A1
(43) Pub. Date: Mar. 27, 2025

(54) BYZANTINE FAULT TOLERANCE FOR INSTANT PAYMENT AND METHODS OF PERFORMING THE SAME

(71) Applicant: 1Money Co., Incline Village, NV (US)

(72) Inventors: Christoph Siebenbrunner, Guntramdorf (AT); Laurent Bindschaedler, Saarbrucken (DE)

(73) Assignee: 1Money Co., Incline Village, NV (US)

(21) Appl. No.: 18/889,574

(22) Filed: Sep. 19, 2024

Related U.S. Application Data
(63) Continuation of application No. 18/648,613, filed on Apr. 29, 2024.
(60) Provisional application No. 63/539,782, filed on Sep. 21, 2023.

(51) Int. Cl. G06Q 20/38; G06Q 20/40

(52) U.S. Cl. CPC G06Q 20/38215; G06Q 20/401

(57) ABSTRACT

A payment management system including a payment management unit that initiates a transaction, an operation unit that manages the issuance of at least one certificate, a governance unit that operates based on at least one parameter defined in the at least one certificate; at least one validation unit that receives the at least one certificate and validates portions of the transaction; and a payment unit that issues payment based on the terms of the at least one certificate, where the operation unit crates a governance protocol for each transaction with the governance protocol including at least one epoch and at least one checkpoint.

### CROSS REFERENCE TO PRIOR APPLICATIONS

This is application claims the benefit of and priority from U.S. Application Ser. No. 63/539,782, filed Sep. 21, 2023 which is fully incorporated herein by reference.

### BACKGROUND OF THE INVENTION

Digital transactions are growing as a method of conducting business between two or more parties. However, due to the nature of digital transactions, no tangible items are used in the transaction. This presents numerous problems including verifying the different aspects of a transaction, initiating payments and the prevention of fraud. In addition, digital transactions can utilize large amounts of processor power, which can further delay the execution of a transaction.

A need exists for a system that will expedite the progression of a transaction without compromising the security of the transaction or utilizing large amount of processing power.

### SUMMARY OF THE INVENTION

Systems, methods, features, and advantages of the present invention will be or will become apparent to one with skill in the art upon examination of the following figures and detailed description. It is intended that all such additional systems, methods, features, and advantages be included within this description, be within the scope of the invention, and be protected by the accompanying claims.

One embodiment of the present disclosure includes a payment management system having a payment management unit that initiates a transaction, an operation unit that manages the issuance of at least one certificate, a governance unit that operates based on at least one parameter defined in the at least one certificate, at least one validation unit that receives the at least one certificate and validates portions of the transaction, and a payment unit that issues payment based on the terms of the at least one certificate where the operation unit crates a governance protocol for each transaction with the governance protocol including at least one epoch and at least one checkpoint.

In another embodiment, the at least one epoch is created by an epoch transition.

In another embodiment, the at least one epoch is associated with a governance certificate generated from the governance unit.

In another embodiment, each checkpoint is created by the at least one validation unit to represent the completion of a task.

In another embodiment, an epoch transition is created when a checkpoint changes a validation parameter.

Another embodiment includes a nonce associated with each transaction.

In another embodiment, the certificate is broadcast to the at least one validation unit over a network.

In another embodiment, at least one checkpoint includes a transaction array listing all the events associated with a transaction.

In another embodiment, a checkpoint proposal is broadcast to selected validation units for acceptance.

In another embodiment, the checkpoint proposal is validated using Byzantine Fault Tolerance.

Another embodiment includes a method of making payments for a transaction including the steps of initiating a transaction via a payment management unit, managing the issuance of at least one certificate via an operation unit, a governance unit based on at least one parameter defined in the at least one certificate, receiving the at least one certificate and validating portions of the transaction via at least one validation unit, issuing a payment based on the terms of the at least one certificate via a payment unit, and creating a governance protocol for each transaction via the governance unit with the governance protocol including at least one epoch and at least one checkpoint.

In another embodiment, the at least one epoch is created by an epoch transition.

Another embodiment includes the step of associating the at least one epoch with a governance certificate generated from the governance unit.

In another embodiment, each checkpoint is created by the at least one validation unit to represent the completion of a task.

Another embodiment includes the step of creating the epoch transition when a checkpoint changes a validation parameter.

Another embodiment includes the step of associating a nonce with each transaction.

Another embodiment includes the step of broadcasting the certificate to the at least one validation unit over a network.

In another embodiment at least one checkpoint includes a transaction array listing all the events associated with a transaction.

Another embodiment includes the step of broadcasting a checkpoint proposal to selected validation units for acceptance.

Another embodiment includes the step of validating the checkpoint proposal is validated using Byzantine Fault Tolerance.

### BRIEF DESCRIPTION OF THE DRAWINGS

The accompanying drawings, which are incorporated in and constitute a part of this specification, illustrate an implementation of the present invention and, together with the description, serve to explain the advantages and principles of the invention. In the drawings:

FIG. 1 depicts one embodiment of a payment management system 100 consistent with the present invention;

FIG. 2 depicts one embodiment of a payment management unit;

FIG. 3 depicts one embodiment of a communication device 104/106 consistent with the present invention;

FIG. 4 depicts a schematic representation of the broadcast system for the payment management system;

FIG. 5 depicts a schematic representation of a system of processing a payment request;

FIG. 6 depicts the schematic representation of a recovery process;

FIG. 7 is a schematic representation of a payment transaction;

FIG. 8 depicts the schematic representation of a checkpoint creation process;

FIG. 9 depicts a schematic representation of a process for creating a governance certificate; and

FIG. 10 is a schematic representation of a payment system.

FIG. 11 depicts a schematic representation of a ledger system.

FIG. 12 depicts a schematic representation of a minting process for a token.

FIG. 13 depicts a schematic representation of a settlement process.

### DETAILED DESCRIPTION OF THE INVENTION

Referring now to the drawings which depict different embodiments consistent with the present invention, wherever possible, the same reference numbers will be used throughout the drawings and the following description to refer to the same or like parts.

The payment management system 100 provides a broadcast based payment system. The payment management system 100 utilizes an account model that allows for redistributing transactions fees, recovery of locked accounts, governance certificates that determine the set of validators and govern protocol parameters like transaction fees, and the creation of checkpoints throughout the transaction process to expediate payment of transaction fees. By the use of an appropriate broadcast scheme such as a signed echo broadcast or any other appropriate broadcast, valid transactions are final as soon as the broadcast is finished, guaranteeing low latency. By the use of governance certificates, which include a checkpoint, validators can be replaced throughout the transaction process, and transaction fees can be paid out upon the completion of the checkpoint. In addition, because each checkpoint consolidates all previously executed transactions, all transactions prior to the checkpoint can be discarded from memory, reducing the memory requirement.

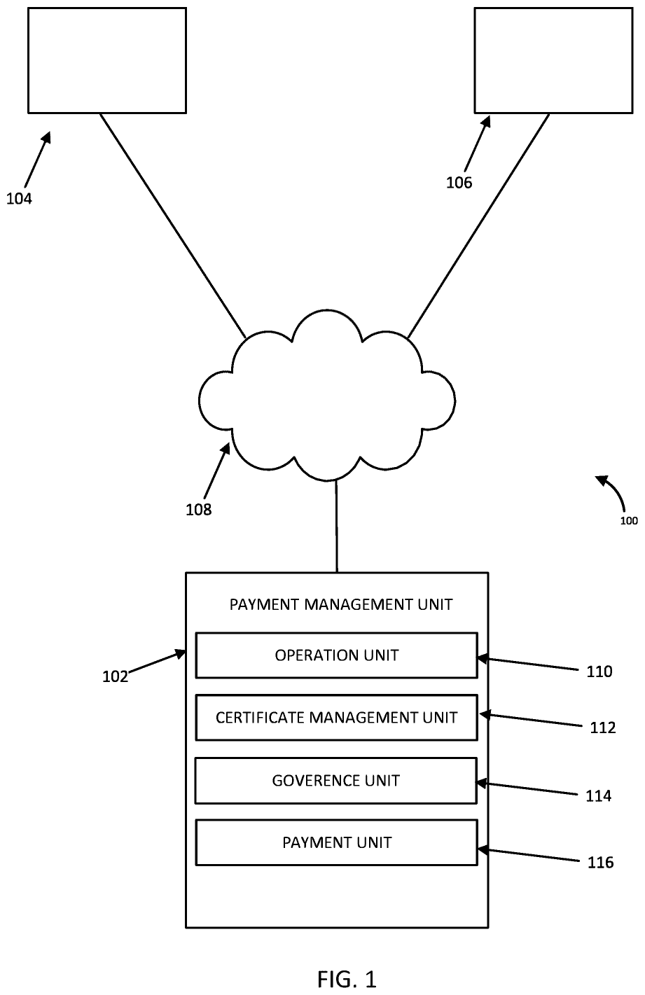

FIG. 1 depicts one embodiment of a payment management system 100 consistent with the present invention. The payment management system 100 includes a payment management unit 102, a communication device 1 104, a communication device 2 106 each communicatively connected via a network 108. The payment management unit 102 further includes an operation unit 110, a certificate management unit 112, a governance unit 114 and a payment unit 116.

The operation unit 110 and certificate management unit 112 may be embodied by one or more servers. Alternatively, each of the governance unit 114 and payment unit 116 may be implemented using any combination of hardware and software, whether as incorporated in a single device or as a functionally distributed across multiple platforms and devices.

In one embodiment, the network 108 is a cellular network, a TCP/IP network, or any other suitable network topology. In another embodiment, the row identification device may be servers, workstations, network appliances or any other suitable data storage devices. In another embodiment, the communication devices 104 and 106 may be any combination of cellular phones, telephones, personal data assistants, or any other suitable communication devices. In one embodiment, the network 108 may be any private or public communication network known to one skilled in the art such as a local area network (“LAN”), wide area network (“WAN”), peer-to-peer network, cellular network, or any suitable network, using standard communication protocols. The network 108 may include hardwired as well as wireless branches.

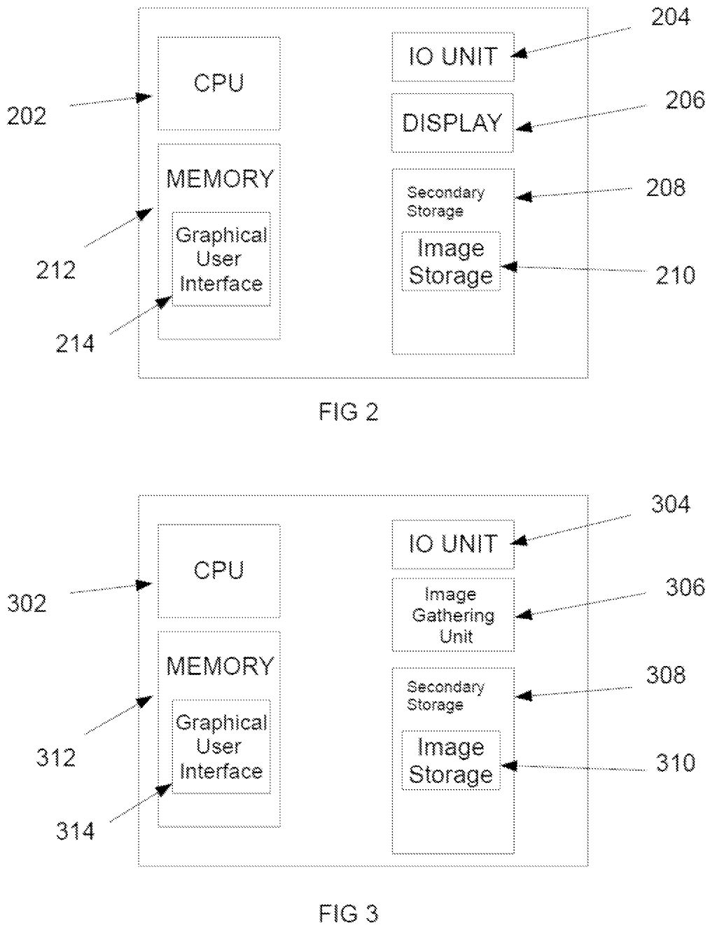

FIG. 2 depicts one embodiment of a payment management unit 102. The payment management unit 102 includes a network I/O device 204, a processor 202, a display 206 and a secondary storage 208 running image storage unit 210 and a memory 212 running a graphical user interface 214. In one embodiment, the processor 202 may be a central processing unit (“CPU”), an application specific integrated circuit (“ASIC”), a microprocessor or any other suitable processing device. The memory 212 may include a hard disk, random access memory, cache, removable media drive, mass storage or configuration suitable as storage for data, instructions, and information. In one embodiment, the memory 208 and processor 202 may be integrated. The memory may use any type of volatile or non-volatile storage techniques and mediums. The network I/O line 204 device may be a network interface card, a cellular interface card, a plain old telephone service (“POTS”) interface card, an ASCII interface card, or any other suitable network interface device. The governance unit 114 may be a compiled program running on a server, a process running on a microprocessor or any other suitable port control software.

FIG. 3 depicts one embodiment of a communication device 104/106 consistent with the present invention. The communication device 104/1106 includes a processor 302, a network I/O Unit 304, an image capture unit 306, a secondary storage unit 308 including an image storage device 310, and memory 312 running a graphical user interface 314. In one embodiment, the processor 302 may be a central processing unit (“CPU”), an application specific integrated circuit (“ASIC”), a microprocessor or any other suitable processing device. The memory 312 may include a hard disk, random access memory, cache, removable media drive, mass storage or configuration suitable as storage for data, instructions, and information. In one embodiment, the memory 312 and processor 302 may be integrated. The memory may use any type of volatile or non-volatile storage techniques and mediums. The network I/O device 304 may be a network interface card, a plain old telephone service (“POTS”) interface card, an ASCII interface card, or any other suitable network interface device.

In one embodiment, the network 108 may be any private or public communication network known to one skilled in the art such as a Local Area Network (“LAN”), Wide Area Network (“WAN”), Peer-to-Peer Network, Cellular network, or any suitable network, using standard communication protocols. The network 108 may include hardwired as well as wireless branches.

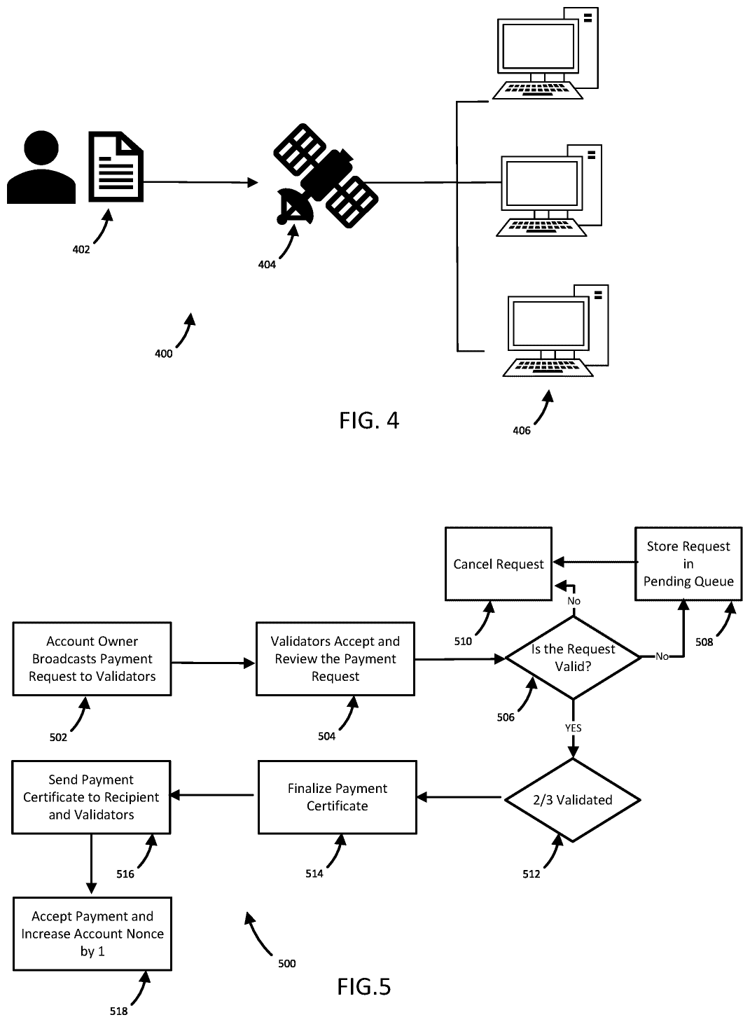

FIG. 4 depicts a schematic representation of the broadcast system 400 for the payment management system 100. An account owner 402 connects to a network 404 and sends out a payment message to a group of validators 406. The payment message is a message that includes the amount to pay, the addresses of the recipients of the funds and identifying information including a nonce associated with the account and a cryptographic signature by the account owner 402. After each validator 406 receives the payment request, the validators review the information in the request and confirm the information is correct. Once two thirds of the validators 406 verify the payment request, signatures of the validators 406 are collected and a payment certificate is sent to the account owner and the recipients of the payment. In one embodiment, the nonce is replaced with the checkpoint identification and/or the epoch identification. Consistent with this embodiment, signed transactions are only valid within one epoch and checkpoint.

In one embodiment, a third party can take the place of the account owner 402 in the process. The third party can transmit a payment message to the account owner 402 and to the validators 406. The third party retains a copy of the payment message and payment certificate after the transaction is complete. The third party, account owner and validators can request notifications of events that occur during the transaction by transmitting a subscribe message that specifies the types of events for notifications and the role of the party requesting notifications. In one embodiment, the roles include account owner, a relayer who is a third party that sends and receives messages for an account owner, a mirror that receives and stores messages related to the account, and a wallet service that can be implemented by a payment application. In another embodiment, a user account is replaced with an Unspent Transaction Output (“UTXO”). Transactions consume one or more UTXOs and send the funds represented by the UTXO to one or more new addresses, thereby creating new UTXOs. Checkpoints can agree on the current state of UTXOs, allowing for the discard of the history, and epoch transitions do not require further adaptation. Transaction fees can be charged by ensuring that the sum of UTXOs is less than the consumed UTXOs and distributed in a checkpoint by creating UTXOs without inputs. UTXOs may also be created with stealth addresses, where only recipients or parties having each party's scanning private keys, have the ability to verify the owner account of a UTXO, thereby providing transaction privacy. Other alternatives for providing privacy include, but are not limited to, signing zero knowledge computation certificates instead of transactions, masking even the existence of a balance. Such privacy-enhancing features may also be combined with the ability to force the operator to reveal balances or transactions by using threshold signatures.

FIG. 5 depicts a schematic representation of a system of processing a payment request 500. In step 502, an account owner issues a payment message to a payment network. The payment message includes the sender's identification, recipients' identification, the amount sent to each recipient, a nonce for the account, and a signature. The payment message is broadcast to all validators on the network. In step 504, validators accept and review the payment request. In reviewing the payment request, each validator verifies the format of the payment message, confirms the nonce is one larger than the last nonce sent from the account, and the account has sufficient funds to pay the amount and any transaction fees. In step 506, each validator determines the validity of the request. The validators make each judgment independently and do not communicate with the other validators. If a request is determined by a validator to have an error that can be corrected, such as a too low balance by the sender, the validator stores the request in a pending queue in step 508. If the request becomes invalid, for example by a different transaction by the same account being finalized, or if the request contains an irrecoverable error, for example a missing signature, the payment request is cancelled in step 510.

In step 512, if the request is determined to be valid by two thirds of the validators reviewing the payment request, the transaction is allowed to move forward. In step 514, a payment certificate is finalized. In finalizing the payment certificate, signatures of at least ⅔ of the validators are included in the payment certificate. The payment certificate can be in any format where at least ⅔ of the validator's signatures are aggregated. The aggregation of signatures may happen using identifiable aggregation, where the identities of the validators whose signature are contained in the aggregate signature can be recovered, and unidentifiable aggregation, where only the presence of a sufficient quantity of signatures is proven. In step 516, the payment certificate is sent to the account owner, any third parties such as relayers, the recipients and the validators. In step 518, funds are transferred to the recipients and the nonce associated with the account is increased by one.

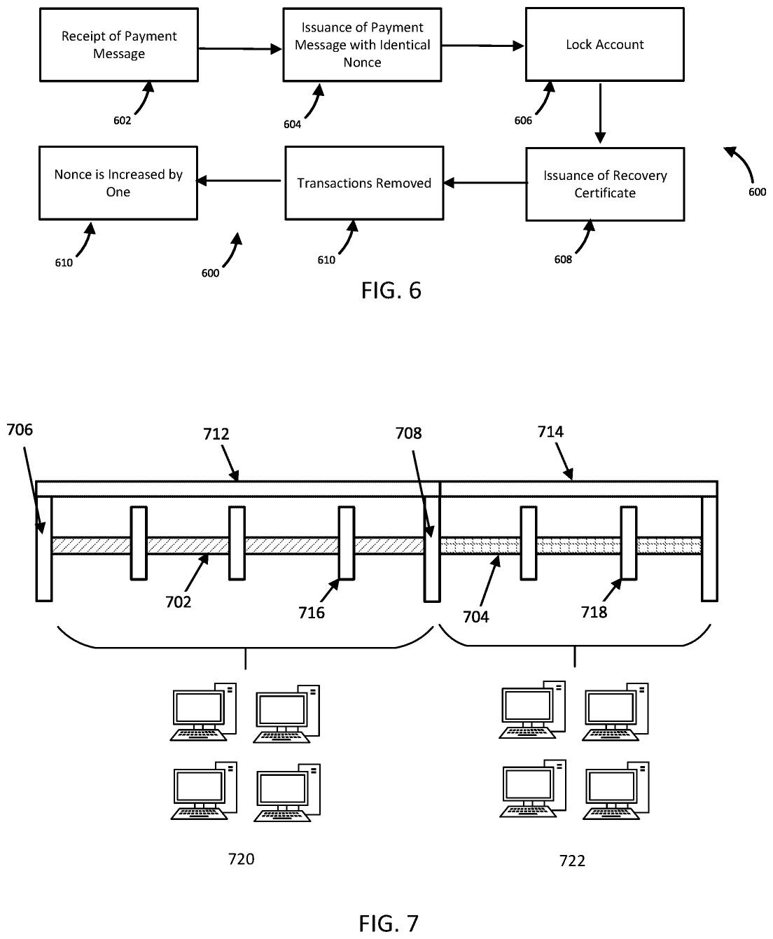

FIG. 6 depicts the schematic representation of a recovery process 600. In step 602, a payment message is transmitted with a nonce to a plurality of at least ⅓ of the validators. In step 604, a second payment message is transmitted with an identical nonce but differing in other fields such as the amount or the recipient to a different plurality of at least ⅓ of the total validators. Because the two payment messages have identical nonces and have been signed by at least ⅓ of the validators each, a two thirds majority of validators cannot be reached. In step 606, the account sending the payment messages with the identical nonces is locked. In step 608, a recovery certificate is sent to the validators. The recovery certificate contains an array of messages with the same nonce along with the signatures for these messages proving that a ⅔ majority for any transaction for this account with this nonce is impossible. A validator receives and validates a recovery message. In step 610, each validator removes the payment messages with the identical nonces. In step 612, the nonce for the account is increased by one any applicable fees are deducted from the account to unlock the account and allow for new transactions.

If an account owner wants to cancel a payment message, the account owner can send a cancellation message to the validators. Upon receipt of the cancellation message, each validator verifies the format of the cancellation message. Once two thirds of the validators have signed the cancellation message, a cancellation certificate is issued and the payment is cancelled. Cancellation messages can be included in a recovery message to confirm an account will be unlocked. In one embodiment, an account owner may dispute a payment. Consistent with this embodiment, final payment will not be made to any account until a predetermined condition, such as an elapsed time, has occurred.

FIG. 7 is a schematic representation of a payment transaction. The validator's signatures of each transaction includes epochs 702 and 704 and a checkpoints 716 and 718 which each represent a distinct time period. Each epoch 702 and 704 is initiated by an epoch transition 706 and 708 that is connected to a governance 712 and 714 for the specific epoch. A governance 712 and 714 represents the rules of the transaction including providing a list of all validators 720 and 722, updating fee parameters, updating a list of banned accounts, and software updates. The governance for each epoch 702 and 704 is transmitted to all parties in a governance certificate 712 and 714. A new epoch 702 and 704 is created for each governance certificate 712 and 714 that is issued. In one embodiment, the information related to epochs and checkpoints is included in the payment message signed by the account. In another embodiment, checkpoints 716 and 718 are only created together with an epoch 702 and 704 and only the epoch information is included in the checkpoint 716 and 718 information.

During an epoch, checkpoints 716 and 718 are created where validators confirm the transactions that have happened up to the point where the checkpoint 716 and 718 occurs in the epoch 702 and 704. In one embodiment, a checkpoint 716 and 718 is issued in the same epoch 702 and 704 without a change in the governance 712 and 714. A checkpoint allows validators to verify the current balance of each account by aggregating all transactions, allowing for the storage of only the balances for each account and to discard the transactions. A checkpoint 716 and 718 that changes protocol parameters or adds or changes validators 722 is an epoch transition 706 and 708, triggering a new epoch 704 with a new governance certificate 714. In one embodiment, the epoch transitions 706 and 708 and the checkpoint 716 and 718 are merged together into a single operation.

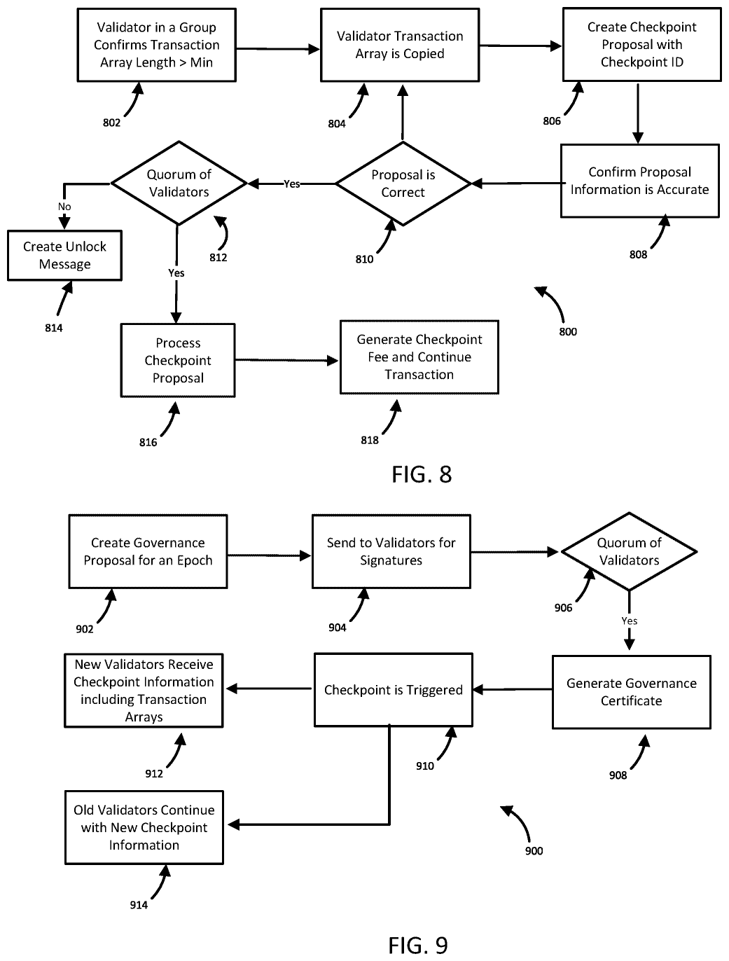

FIG. 8 depicts the schematic representation of a checkpoint creation process. In step 802, a validator, or any node, associated with a transaction confirms the transaction array length is greater than a minimum value. In one embodiment, the checkpoint 716 and 718 creation are triggered by a different event such as a request by a validator or an operator. In another embodiment, a checkpoint 716 and 718 is triggered after a predetermined amount of time has elapsed. In step 804, the validator creating the checkpoint makes a copy of the validator's transaction array. In one embodiment, the copy of the transaction array may be a simple array. In another embodiment, the copy of the transaction array may use an efficient data structure such as a Merkle tree. In step 806, the validator creates a checkpoint proposal that includes the checkpoint identifier, a signature and the transaction array. The transaction array includes a listing of all transactions the validator has identified a certificate associated with the transaction. After creating the checkpoint proposal, the validator starts signing certificates with the checkpoint identifier for the next checkpoint. The validator then sends the checkpoint proposal to the other validators. In step 808, each validator confirms the information in the checkpoint proposal is correct by confirming the conditions for creating a checkpoint are met, each transaction includes correct certificates with checkpoint identifiers up to the last identifier and the transactions each increment the account nonce by one. In step 810, each validator confirms the checkpoint proposal is correct. If a validator receiving a checkpoint proposal has witnessed more transaction certificates than what is included in a checkpoint proposal received by the validator, the validator creates a new transaction array 804 and send out a new checkpoint proposal 806 that includes an updated transaction array including the previously missing transactions. In one embodiment, the validity of the checkpoint proposal is confirmed using practical Byzantine Fault Tolerance (“BFT”). In another embodiment, the validity of the certificate proposal is confirmed using exponential information gathering, Tendermint, Narwhal/Bullshark, and generally all BFT consensus algorithms where authenticated nodes may be assumed in BFT proofs. In step 812, a quorum of ⅔ of validators confirms the checkpoint proposal is correct. In step 814, if different validators have confirmed different checkpoint proposals such that no proposal can reach ⅔ confirmations, an unlock message is created and sent out in step 814. The unlock message contains proof that a quorum is not possible along with a new checkpoint proposal.

In step 816, each validator processes the checkpoint proposal. After the proposal is processed, each validator hashes the state of all accounts and signs the checkpoint hash. In another embodiment, validators sign the hash of the transaction array. Each validator sends the checkpoint hash out over the network. Moving forward, validators sign any new certificates with the new checkpoint identifier. In step 818, the transaction fees of all transactions included in the checkpoint are calculated and paid to all validators participating in the transaction and the transaction continues. In another embodiment of the checkpoint creation process, validators use a consensus to agree on the transactions in the checkpoint.

FIG. 9 depicts a schematic representation of a process for creating a governance certificate. In step 902, a governance proposal is created. In step 904, the governance proposal is sent to all validators and each validator signs the proposal. In step 906, a quorum of at least ⅔ of the validators for the current epoch sign the proposal. In step 908, once a quorum of signatures is reached, a governance certificate is created. In one embodiment, a governance certificate is created by a central operator. In step 910, the generation of a governance certificate triggers the creation of a new checkpoint. The new checkpoint ends the current epoch and creates a new epoch controlled by the new governance certificate. The new governance certificate may remove validators, add validators, or exchange validators and set protocol parameters for the new epoch. In step 912, new validators receive checkpoint information including a full list of certificates for transactions associated with the previous epoch. In step 914, existing validators receive the new checkpoint identifier and continue signing requests. Moving forward, each validator uses the new epoch identifier.

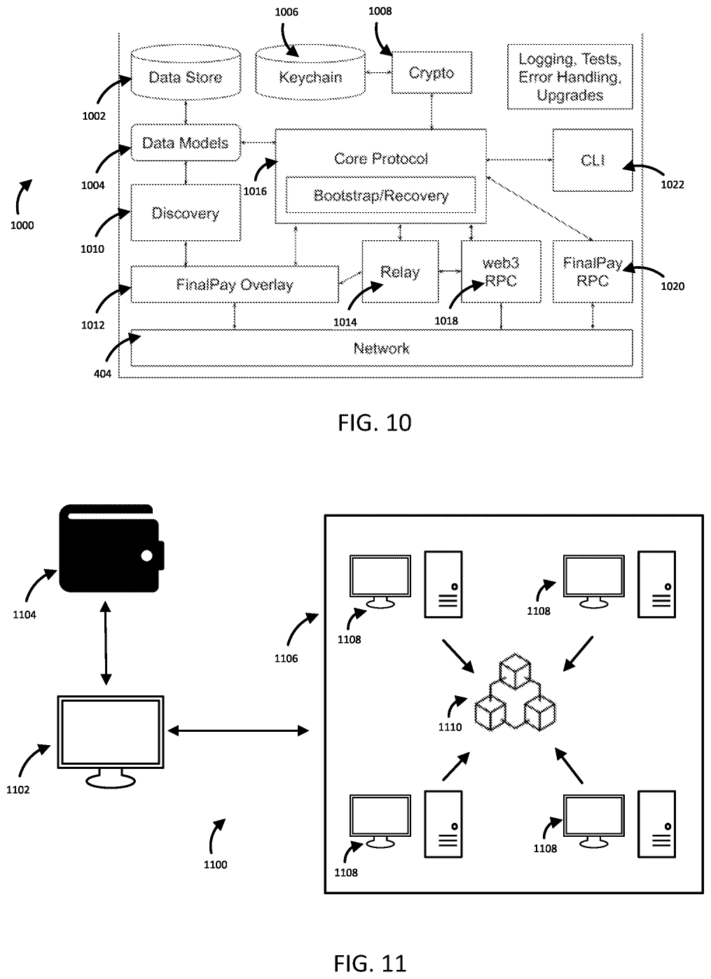

FIG. 10 is a schematic representation of a payment system 1000. The payment system 1000 includes a data store 1002 that stores all relevant data including nonces, account information including balances and other payment process data. A data model 1004 is connected to the data store 1002. The data model 1004 allows querying and modifying the protocol-related system state parameters and other data stored in the data store 1002. On a system level, the data model 1004 gets and sets checkpoint and epoch identifiers, issues checkpoints, manages governance certificates and manages the certificates issued for a transaction. The data model 1004 also manages the accounts of account holders including monitoring account balances and nonces for an account. The data model 1004 also manages the addresses of validators.

The payment system 1000 also includes a keychain 1006 and a crypto module 1008. The keychain 1006 stores private keys used to access the system and the crypto module 1008 provides an interface to sign transactions using the private keys. The crypto module 1008 also manages all signatures including aggregating signatures for certificates that are created. A discovery module 1010 is connected to the data model 1004 and discovers new nodes on the network 404. A FinalPay overlay 1012 is connected to the discovery module 1010 and manages broadcasts made over the network including payment request broadcasts and checkpoint broadcasts. A relay module 1014 is connected to the overlay 1012 which controls validator to validator communications.

The data model 1004, overlay 1012 and relay module 1014 are all connected to a core protocol module 1016. The core protocol module 1016 manages all operations 1016 of the payment system 1000 including managing transactions, initiating checkpoints, managing governance certificates, and updating account information. A Web3 RPC 1018 is connected to the core protocol module to convert Ethereum based messages to common format. A FinalPay RPC 1020 is connected to the core protocol module 1016 and manages messages sent from external sources to the core protocol module 1016. A CLI module 1020. A CLI module 1022 that handles addressing of nodes is connected to the core protocol module 1016.

FIG. 11 depicts a schematic representation of a ledger system 1100. The ledger system 1100 includes a safe investment financial account unit 1104 communicatively connected to a trusted operator unit 1102. The safe investment financial account unit 1102 may be any monetary account including, but not limited to, a bank account, investment account or cryptocurrency wallet. The trusted operator unit 1102 is communicatively coupled to a distributed ledger technology (“DLT”) system 1106. The DLT system 1106 consists of validator units 1108 that each communicate under the rules of a DLT protocol 1100. In one embodiment, the DLT protocol 1110 is a level one transaction protocol. The DLT protocol 1110 ensures eventual consistency of the ledger records under Byzantine Fault Tolerance using a consensus mechanism, such as deterministic security guarantees using Ethereum or Solana blockchain, or a broadcast mechanism. The DLT protocol 1110 may also incorporate sybil protection mechanism such as proof-of-state or proof-of-authority permission.

The validator units 1108 replicates a ledger of balances for all accounts. The ledger system has a data structure that stores at least one token balance per account and verifies that adequate funds exist in the safe investment financial account unit 1104 to financially back each newly minted token. The ledger may also store nonces or transaction counters, text including code and the state of a smart contract. The data structure may be a list, a hashmap or another appropriate data structure. Transactions under the ledger system are in the form of messages including a sender, a receiver and an amount. Each message is signed by the sender using public key cryptography or UTXO.

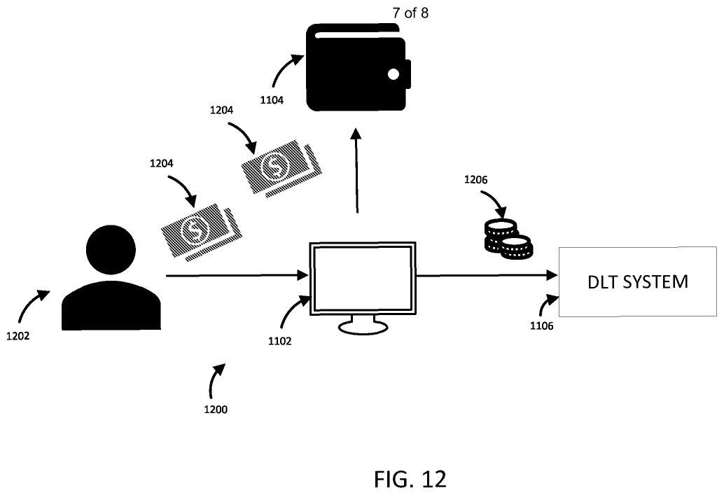

FIG. 12 depicts a schematic representation of a minting process 1200 for a token. The DLT protocol 1100 includes a plurality of tokens with each token corresponding to a unit of fiat currency held in the safe investment financial account unit 1104. A user 1202 sends money 1204, or proof of funds in the safe investment financial account unit 1104, to the operator unit 1102 using traditional means of payment such as a bank transfer. The operator unit 1102 transmits a mint transaction 1206 to the DLT system 1106. The mint transaction 1206 represents a transaction that has one of potentially multiple mint safe investment financial account unit 1102 as the sender. safe investment financial account unit 1104 are defined in the DLT protocol 1110 and can be changed using the DLT protocol 1110. Changing safe investment financial account unit 1104 requires the signature of the operator unit 1202. safe investment financial account unit 1104 includes accounts that are defined to have a balance of zero or any arbitrary balance that is not counted towards the total fiat-backed token supply, but may always send arbitrary amounts to other accounts. The operator unit 1202 is trusted to only issue a mint transaction when the safe investment wallet unit 1204 has a corresponding inflow of a fiat currency.

A burn transaction is a transaction with a safe investment financial account unit 1104 as a recipient. Users 1202 can withdraw tokens 1206 from the DLT system 1106 to convert the tokens 1206 back into fiat cash 1204 by providing payment details such as a bank account number to the operator and issue a burn transaction. Once the burn transaction has been finalized by the BFT protocol, the operator unit 1102 issues a fiat payment to the recipient, using the funds invested in the safe asset and the previously minted tokens are removed from the ledger. In one embodiment, where funds were not transferred to the operator unit 1102, the burn process clears the ledger of tokens minted with untransformed funds.

In one embodiment, the DLT protocol 1110 may include a plurality of subsystem including, but not limited to, a payment sub-system, a checkpoint sub-system and a governance sub-system. The payment sub-system control payments, cancellations and recoveries and is controlled by a broadcast mode. The checkpoints sub-system controls memory management including deleting prior transactions and payment of transaction fees. The checkpoints sub-system is controlled by a consensus mode. The governance sub-system controls the updates to protocol parameters and committed management. The governance sub-system is controlled by a consensus mode. The minted tokens may be used to pay transaction fees or any other required settlement.

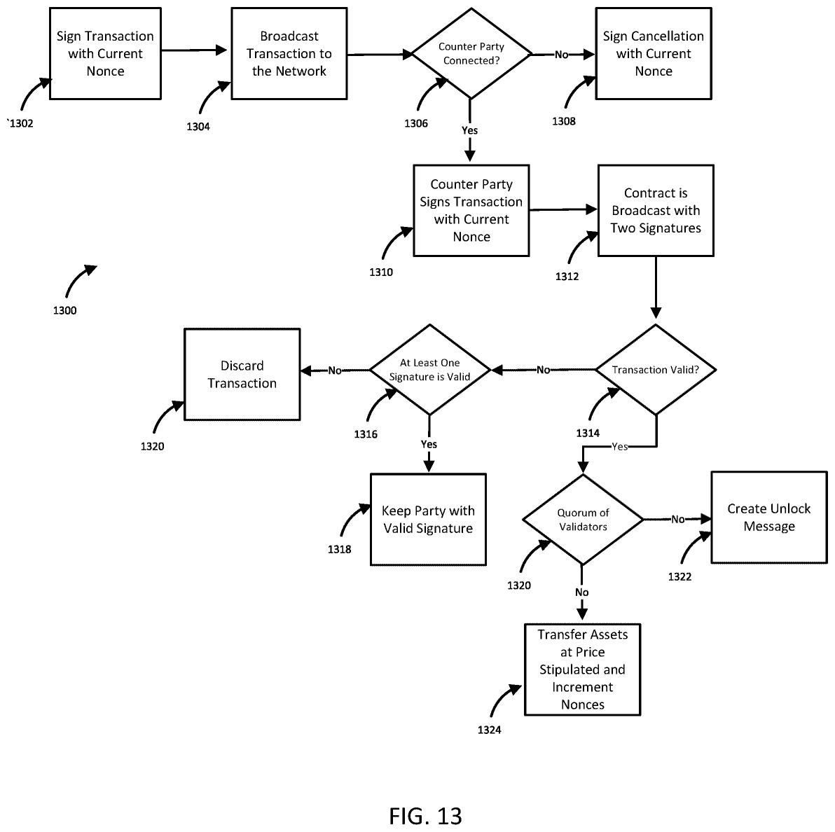

FIG. 13 depicts a schematic representation of a settlement process 1300. In step 1302, a transaction is signed by a first party to a transaction. In step 1304, the signed transaction is broadcast on a network. In step 1306, the first party waits until the second party is connected to the network. In step 1308, if the second party does not connect, the first party signs a cancellation for the transaction. In step 1310, if the second party connects to the network, the second party signs the transaction using the current nonce. In step 1312, the contract signed by both parties is broadcast on the network. In step 1314, a plurality of validators determines if the transaction is valid. In step 1316, the validators check if at least one signature is valid. In step 1320, if no signatures are valid, the transaction is discarded. In step 1318, if one signature is valid, the contract is kept for the valid signing party. In step 1320, if the transaction is valid, the validator confirms if a quorum of validators has validated the transaction. In step 1322, if a quorum has not validated the transaction, an unlock code is generated and the transaction is locked. In step 1324, if the transaction is validated by a quorum, assets are transferred between the parties at a predetermined price and each party's nonce is incremented.

While various embodiments of the present invention have been described, it will be apparent to those of skill in the art that many more embodiments and implementations are possible that are within the scope of this invention. Accordingly, the present invention is not to be restricted except in light of the attached claims and their equivalents.

1.-20. (canceled)

21. A method for updating user balances in a cryptographic transmission system based on values in an external system separate from the cryptographic transmission system, the cryptographic transmission system comprising a network of validation units, the network of validation units each storing a respective data structure indicating balances of a plurality of users in the cryptographic transmission system, the method comprising:
using at least one computer hardware processor to perform:
receiving from, the external system, an indication of a first value in the external system associated with a first user of the plurality of users;
determining, based on the first value in the external system associated with the first user, a first amount to issue to a balance of the first user in the cryptographic transmission system; and
transmitting, to the network of validation units, a first message indicating the first amount to issue to the first user, wherein transmitting the first message causes the network of validation units to update respective data structures at least in part by adding the first amount indicated by the first message to the balance of the first user in the cryptographic transmission system.

22. The method of claim 21, further comprising:
generating the first message indicating the first amount to issue to the first user at least in part by cryptographically signing the first message with a cryptographic signature of an operator unit designated for initiating amounts in the cryptographic transmission system.

23. The method of claim 21, further comprising:
receiving from, the external system, an indication of a second value in the external system associated with a second user of the plurality of users;
determining, based on the second value in the external system associated with the second user, a second amount to issue to a balance of the second user; and
transmitting, to the network of validation units, a second message indicating the second amount to issue to the second user, wherein transmitting the second message causes the network of validation units to update respective data structures at least in part by adding the second amount indicated by the second message to the balance of the second user.

24. The method of claim 21, further comprising:
receiving, from a device by the network of validation units, a second message requesting transmission of a second amount from the first user to at least one recipient;
validating, by each of at least some of the network of validation units, the transmission requested by the second message at least in part by:
determining whether the balance of the first user is sufficient to complete the transmission of the second amount to the at least one recipient; and
when it is determined that the balance of the first user is sufficient to complete the transmission of the second amount to the at least one recipient:
cryptographically signing the second message with a cryptographic signature of the validation unit indicating that the transmission is valid to obtain a cryptographically signed second message; and
transmitting, to the device, the cryptographically signed second message.

25. The method of claim 24, further comprising performing, by the device:
in response to receiving, from the network of validation units, a threshold number of cryptographic signatures indicating that the transmission requested by the second message is valid:
generating a validation certificate using the cryptographic signatures; and
transmitting, to the at least one recipient and the network of validation units, the validation certificate, wherein transmission of the validation certificate triggers execution of the transmission from the first user to the at least one recipient.

26. The method of claim 24, further comprising performing, by at least some of the network of validation units:
determining that the network of validation units has reached a consensus that the transmission requested by the second message is valid; and
in response to determining that the network of validation units has reached the consensus, updating respective data structures by updating the balance of the first user in the respective data structures and updating at least one balance of the at least one recipient in the respective data structures.

27. The method of claim 24, further comprising performing, by at least some of the network of validation units:
receiving, from the device, a validation certificate indicating that a threshold number of validation units have determined that the transmission requested by the second message is valid; and
in response to receiving the validation certificate, updating respective data structures by updating the balance of the first user in the respective data structures and updating at least one balance of the at least one recipient in the respective data structures

28. The method of claim 21, further comprising:
generating the first message indicating the first amount to issue to the first user by including, in the first message, information indicating a transmission of the first amount from a sender to the first user.

29. The method of claim 21, further comprising:
receiving, from a device by the network of validation units, a second message requesting transmission of a second amount from the balance of the first user to the external system;
validating, by each of at least some of the network of validation units, the transmission requested by the second message at least in part by:
determining whether the balance of the first user is sufficient to complete the transmission of the second amount from the balance of the first user to the external system; and
when it is determined that the balance of the first user is sufficient to complete the transmission of the second amount to the external system:
cryptographically signing the second message with a cryptographic signature of the validation unit indicating that the transmission is valid to obtain a cryptographically signed second message; and
transmitting, to the device, the cryptographically signed second message.

30. The method of claim 29, further comprising:
in response to receiving, from the network of validation units, a threshold number of cryptographic signatures indicating that the transmission requested by the second message is valid:
transmitting a second value, based on the second amount, to the first user in the external system.

31. A cryptographic transmission system comprising:
a network of validation units each storing a respective data structure indicating balances of a plurality of users in the cryptographic transmission system; and
at least one computer hardware processor configured to:
receive from, the external system, an indication of a first value in the external system associated with a first user of the plurality of users;
determine, based on the first value in the external system associated with the first user, a first amount to issue to a balance of the first user in the cryptographic transmission system; and
transmit, to the network of validation units, a first message indicating the first amount to issue to the first user, wherein transmitting the first message causes the network of validation units to update respective data structures at least in part by adding the first amount indicated by the first message to the balance of the first user in the cryptographic transmission system.

32. The system of claim 31, wherein the at least one computer hardware processor is further configured to:
generate the first message indicating the first amount to issue to the first user at least in part by cryptographically signing the first message with a cryptographic signature of an operator unit designated for initiating amounts in the cryptographic transmission system.

33. The system of claim 31, wherein the at least one computer hardware processor is further configured to:
receive from, the external system, an indication of a second value in the external system associated with a second user of the plurality of users;
determine, based on the second value in the external system associated with the second user, a second amount to issue to a balance of the second user; and
transmit, to the network of validation units, a second message indicating the second amount to issue to the second user, wherein transmitting the second message causes the network of validation units to update respective data structures at least in part by adding the second amount indicated by the second message to the balance of the second user.

34. The system of claim 31, wherein:
the at least one computer hardware processor is further configured to receive, from a device by the network of validation units, a second message requesting transmission of a second amount from the first user to at least one recipient; and
each of at least some of the network of validation units is configured to validate the transmission requested by the second message at least in part by performing:
determine whether the balance of the first user is sufficient to complete the transmission of the second amount to the at least one recipient; and
when it is determined that the balance of the first user is sufficient to complete the transmission of the second amount to the at least one recipient:
cryptographically sign the second message with a cryptographic signature of the validation unit indicating that the transmission is valid to obtain a cryptographically signed second message; and
transmit, to the device, the cryptographically signed second message.

35. The system of claim 34, further comprising the device, wherein the device is configured to:
in response to receiving, from the network of validation units, a threshold number of cryptographic signatures indicating that the transmission requested by the second message is valid:
generate a validation certificate using the cryptographic signatures; and
transmit, to the at least one recipient and the network of validation units, the validation certificate, wherein transmission of the validation certificate triggers execution of the transmission from the first user to the at least one recipient.

36. The system of claim 34, wherein at least some of the network of validation units are configured to:
determine that the network of validation units has reached a consensus that the transmission requested by the second message is valid; and
in response to determining that the network of validation units has reached the consensus, update respective data structures by updating the balance of the first user in the respective data structures and updating at least one balance of the at least one recipient in the respective data structures.

37. The system of claim 34, wherein at least some of the network of validation units are configured to:
receive, from the device, a validation certificate indicating that a threshold number of validation units have determined that the transmission requested by the second message is valid; and
in response to receiving the validation certificate, update respective data structures by updating the balance of the first user in the respective data structures and updating at least one balance of the at least one recipient in the respective data structures

38. The system of claim 31, wherein the at least one computer hardware processor is further configured to:
generate the first message indicating the first amount to issue to the first user by including, in the first message, information indicating a transmission of the first amount from a sender to the first user.

39. The system of claim 31, wherein:
the at least one computer hardware processor is further configured to receive, from a device by the network of validation units, a second message requesting transmission of a second amount from the balance of the first user to the external system; and
each of at least some of the network of validation units are configured to validate the transmission requested by the second message at least in part by performing:
determine whether the balance of the first user is sufficient to complete the transmission of the second amount from the balance of the first user to the external system; and
when it is determined that the balance of the first user is sufficient to complete the transmission of the second amount to the external system:
cryptographically sign the second message with a cryptographic signature of the validation unit indicating that the transmission is valid to obtain a cryptographically signed second message; and
transmit, to the device, the cryptographically signed second message.

40. A non-transitory computer-readable storage medium storing instructions that, when executed by a processor, cause the processor to perform a method for updating user balances in a cryptographic transmission system based on values in an external system separate from the cryptographic transmission system, the cryptographic transmission system comprising a network of validation units, the network of validation units each storing a respective data structure indicating balances of a plurality of users in the cryptographic transmission system, the method comprising:
receiving from, the external system, an indication of a first value in the external system associated with a first user of the plurality of users;
determining, based on the first value in the external system associated with the first user, a first amount to issue to a balance of the first user in the cryptographic transmission system; and
transmitting, to the network of validation units, a first message indicating the first amount to issue to the first user, wherein transmitting the first message causes the network of validation units to update respective data structures at least in part by adding the first amount indicated by the first message to the balance of the first user in the cryptographic transmission system.
